(19) United States
(12) Patent Application Publication
(10) Pub. No.: US 2016/0204868 A1
(43) Pub. Date: Jul. 14, 2016

(54) Summation of Parallel Modulated Signals of Different Wavelengths

(71) Applicant: Huawei Technologies Co., Ltd., Shenzhen (CN)

(72) Inventors: Dritan Celo, Ottawa (CA); Dominic John Goodwill, Ottawa (CA); Mikelis Svilans, Ottawa (CA)

(21) Appl. No.: 14/726,037

(22) Filed: May 29, 2015

Related U.S. Application Data
(63) Continuation-in-part of application No. 14/595,849, filed on Jan. 13, 2015.

(51) Int. Cl. H04B 10/516; H04J 14/02

(52) U.S. Cl. CPC H04B 10/516; H04J 14/02

(57) ABSTRACT

An optical transmitter is provided. The optical transmitter includes a first optical modulator configured to modulate a first optical carrier signal having a first wavelength and a first power using a first data bit to generate a first modulated output signal, a second optical modulator configured to modulate a second optical carrier signal having a second wavelength and a second power using a second data bit to generate a second modulated output signal, wherein the second optical modulator and the first optical modulator modulate in parallel, and an optical wavelength multiplexer configured to sum the first modulated output signal and the second modulated output signal into an analog signal suitable for transmission over an optical fiber.

### CROSS-REFERENCE TO RELATED APPLICATIONS

This patent application is a continuation of co-pending U.S. patent application Ser. No. 14/595,849, filed Jan. 13, 2015, by Dominic Goodwill entitled “Optical Power System for Digital-to-Analog Link,” the teachings and disclosure of which are hereby incorporated in their entireties by reference thereto.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Mobile communication networks transmit data to one or more devices (e.g., mobile phone, tablet computer, etc.) using radio frequency (RF) signals. The RF signals are radiated from a transmission antenna, which is located at a cellular tower or transmission site. It may be desirable to reduce the amount of equipment proximate the transmission antenna or at the transmission site. To do so, the equipment used to create an analog signal that drives the transmission antenna is located remotely from the transmission antenna with cabling between the locations. By way of example, the equipment used to create the analog signal may be disposed at the base of the cellular tower or at a location a few kilometers or tens of kilometers away from the cellular tower.

It can be challenging to carry the analog signal over electrical cabling, due to the large weight and poor signal integrity of electrical cables. Therefore, the analog signal may be carried on an optical fiber using an optical carrier. This and similar arrangements are known as a radio-over-fiber (RoF) system or an RF-over-fiber system.

The analog signal used to drive the transmission antenna may be synthesized from a digital signal. For example, the digital signal may be converted to an analog signal using a digital-to-analog (D-to-A) modulator driven by multiple electrical digital bits in parallel. Unfortunately, existing D-to-A modulators may not be sufficient to handle newer generations of mobile communications technology.

### SUMMARY

In one embodiment, the disclosure includes an optical transmitter including a first optical modulator configured to modulate a first optical carrier signal having a first wavelength and a first power using a first data bit to generate a first modulated output signal, a second optical modulator configured to modulate a second optical carrier signal having a second wavelength and a second power using a second data bit to generate a second modulated output signal, wherein the second optical modulator and the first optical modulator modulate in parallel, and an optical wavelength multiplexer configured to sum the first modulated output signal and the second modulated output signal into an analog signal suitable for transmission over an optical link.

In another embodiment, the disclosure includes an optical transmitter including optical modulators configured to modulate optical carrier signals each having a different wavelength, wherein modulation by the optical modulators is performed in parallel on the optical carrier signals from a highest power optical carrier signal modulated using a most significant bit of a digital signal through a lowest power optical carrier signal modulated using a least significant bit of the digital signal to generate modulated output signals, and an optical wavelength multiplexer configured to sum the modulated output signals into an analog signal suitable for transmission to an analog photoreceiver over an optical fiber.

In yet another embodiment, the disclosure includes a method of optical transmission including modulating, using one optical modulator, an optical carrier signal having a first wavelength and a highest power using a most significant bit to generate a modulated output signal, modulating, using another optical modulator, another optical carrier signal having a different wavelength and a next-highest power using a next most significant bit to generate another modulated output signal, repeating the modulating, using a further optical modulator, until modulating a final optical carrier signal having a final wavelength with a lowest power using a least significant bit to generate further modulated output signals, and combining all of the modulated output signals into a modulated analog signal suitable for transmission over an optical fiber.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an embodiment of a RF-over-fiber system.

FIG. 2 is a schematic diagram of an embodiment of an optical transmitter within an optical system and configured to perform modulation in parallel.

FIG. 3 is a schematic diagram of an embodiment of an optical transmitter on a photonic integrated circuit.

FIG. 4 is a schematic diagram of an embodiment of an optical transmitter including four optical modulators and a 4-bit digital signal.

FIG. 5 is a schematic diagram of an embodiment of optical splitters dividing optical carrier signals from lasers for use by four of the optical transmitters.

FIG. 6 is schematic diagram of an embodiment of a digital-to-analog communication link.

FIG. 7 is a flowchart of an embodiment of an optical transmission method.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Disclosed herein is an optical transmitter configured to perform modulation of optical signals in parallel in an optical system. As will be more fully explained below, the optical transmitter is able to modulate optical carrier signals having different wavelengths and different powers using bits from a digital signal to generate modulated output signals. The modulated output signals are combined into an analog signal, which may be transmitted to a photoreceiver over an optical fiber. In other words, the optical transmitter is able to perform a digital-to-analog conversion in a manner suitable to handle newer generations of mobile communications technology, such as the fifth generation (5G) mobile communications technology.

In a mobile communication network, data is transmitted to mobile devices using a radio frequency (RF) transmitter. An analog RF signal is provided to a transmission antenna that radiates the signal to the respective communication clients. The analog RF signal may be provided to a cellular tower, or transmission site, in various manners. For example, the analog signal may be communicated to the transmission site as a digital representation of the desired analog signal. An analog signal is synthesized from the digital signal and is power amplified in order to provide the RF signal for driving the transmission antenna.

If there are multiple transmission antennae, then multiple optical signals may be used; although it is possible for a single analog signal to drive multiple transmission antennae. Similarly, a single transmission antenna may be driven by multiple analog signals. When a single antenna is driven by multiple analog signals, the analog signals may drive the single antenna at different times, or the analog signals may have non-overlapping wavelengths to allow driving the same antenna at the same time. The use of analog optical signals for transmitting the signals for driving the transmission antennae may reduce the amount of equipment at the transmission antennae since it is not necessary to first convert a digital signal to an analog signal.

The digital signal may comprise a time series of digital words, providing a digital word stream. Each digital word may comprise a plurality of data bits, providing a plurality of digital bit streams. A digital signal may be converted to an analog optical signal by modulating an optical carrier wave so that the optical power of the carrier wave corresponds to the magnitude of the digital signal. An optical power supply provides unmodulated optical carrier wave that can be modulated according to the digital signal.

The analog signal may be provided as a modulated carrier wave of a single wavelength, or may be provided as a multiplexed signal of a plurality of carrier waves. When a single analog signal is provided by multiplexing a plurality of individual optical carrier waves together, each optical carrier wave used for an analog signal may have a different wavelength and may be modulated according to a bit of the digital signal. The modulated optical carrier waves may then be multiplexed together into a single analog optical signal corresponding to the data signal.

To carry multiple analog signals that emanate from the same location, there may be multiple digital-to-analog transmitters that synthesize an optical analog signal from a digital signal. Multiple high-power lasers may provide optical carrier waves at respective wavelengths. The optical carrier waves output by the lasers may be shared across the multiple digital-to-analog transmitters by means of optical power splitting before the carrier waves are modulated by the digital signal.

The use of a relatively small number of high-powered lasers to provide all of the optical carrier waves for modulating multiple analog signals may provide savings in terms of cost and/or size. That is, a small number of high-power lasers may be less costly than a large number of low-power lasers. Similarly, a small number of high-power lasers may require less space than a large number of low-power lasers, which may simplify the installation of the required components. Further, the technical requirements of the analog RF signal for transmission, and so the technical requirements of the analog optical signal, may be demanding. In particular, the lasers providing the optical carrier waves should have very low relative intensity noise (RIN) in the important frequency range, which in the case of wireless transmissions, such as cellular transmission, is in the range of one gigahertz (GHz). Meeting the requirements may be easier, and possibly more cost effective, using a small number of high-powered lasers, as the RIN of a laser generally decreases in the important frequency range as the laser is operated at higher power. Further, the use of high-powered lasers may provide sufficiently high optical power to overcome photon statistical shot noise at the receiver.

As described further below, an optical power system for use in a digital-to-analog optical transmission environment may include a number of high-powered lasers, each of differing wavelengths. In an embodiment, the output of each of the lasers at the output port has a different power. In another embodiment, the output of the lasers is split into a number of ports each with differing power. Each of the output ports may be modulated according to a bit of a data signal. The modulated optical carrier waves for the bits of a data signal may then be multiplexed together to provide the analog optical signal for transmission. As described in further detail below, different optical wavelengths provided from different lasers may be used to modulate individual bits of a particular signal.

Although discussion is provided below with the terminology used in 3G/4G networks, including reference to Base Station Controllers, Radio Network controllers and Base transceiver stations, it should be understood that other names for similar nodes and functions may be appropriate. A separation of the antennas, often referred to as a remote radio head, from the network access point which generates the analog representations of digital signals for transmissions, can be useful in future generations of wireless networks and can enable different architectures.

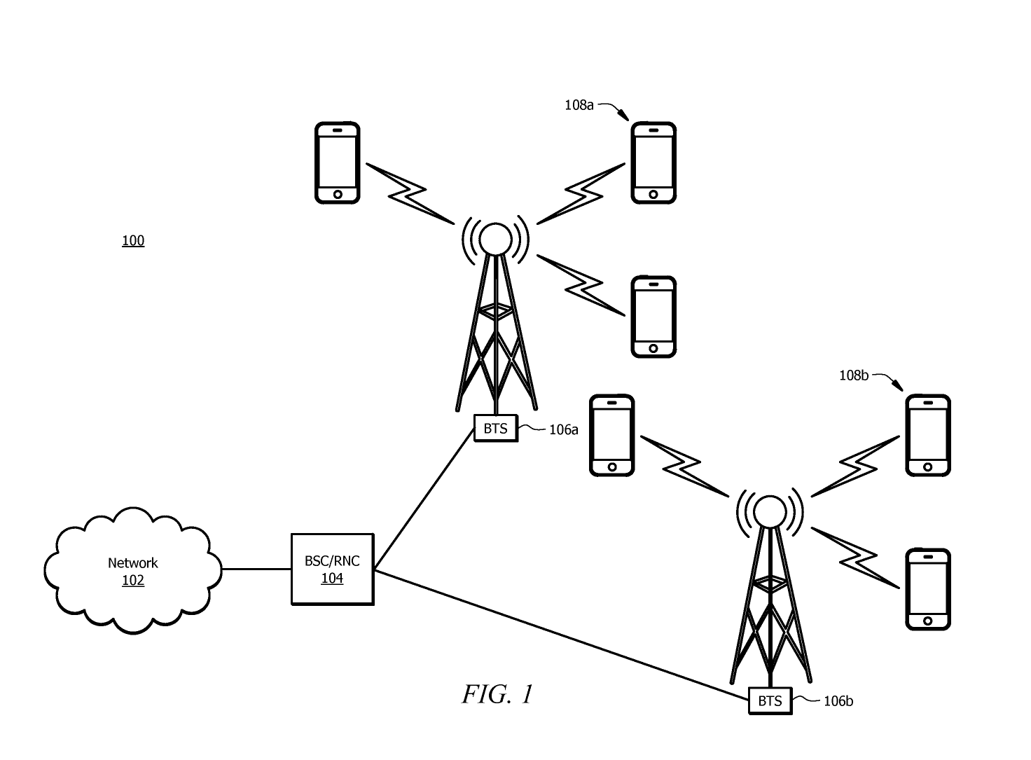

FIG. 1 depicts an environment 100 in which an optical power system may be utilized. The environment 100 depicted is a mobile communication network. The mobile communication network includes a network 102, which may include various systems for controlling and coordinating the communication network. For example, the network 102 may include computing devices for providing data or other services, such as a web server. Although depicted as exterior to the network 102, the additional components depicted in FIG. 1 may be considered as part of the network 102.

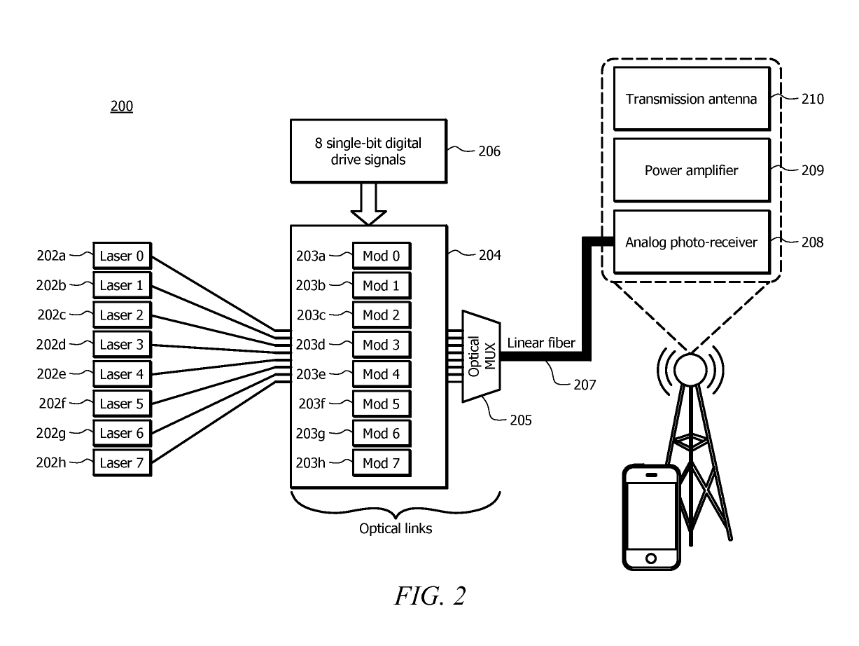

Base station controllers (BSC) and/or radio network controllers (RNC) 104, depending upon the network technology, control a number of transmission sites. The controller 104 communicates with communication equipment located at the transmission site, depicted as base transceiver stations (BTS) 106a, 106b (referred to collectively as BTS 106). Broadly, the BTS 106 receives data for transmission from, for example, controller 104 and provides the analog RF signal for driving a transmission antenna (e.g., transmission antenna 210 in FIG. 2). The transmitted RF signals are received by one or more mobile devices 108a, 108b (referred to collectively as devices 108) associated with the respective BTS 106. The devices 108 may be mobile phone, tablet computers, and so on.

Previously, the analog signal for driving the transmission antenna was generated in close proximity to the transmission antenna in order to avoid signal degradation caused by transmission of an analog electrical signal. Accordingly, communication equipment for performing the digital-to-analog conversion was required at the transmission antenna. By providing the analog signal as an optical signal, longer transmission lengths are possible without significant signal degradation. Accordingly, it is possible to place the digital-to-analog conversion equipment at a location remote from the transmission antenna, and only provide optical to electrical conversion components and power amplifiers in the vicinity of the transmission antenna.

The optical transmitter described herein may be used in providing the analog signals for use in driving transmission antennae. The optical transmitter may include an optical power system that provides unmodulated optical carrier waves at different power levels and wavelengths using a relatively small number of high powered lasers. The outputs from the lasers may be split into a number of ports and the carrier waves from the ports may be modulated according to bits of the digital signals. The generated optical analog signals may be transmitted a relatively short distance, for example from the base of a transmission tower to the top of the transmission tower where the antenna is located. Additionally, or alternatively, the analog optical signal may be transmitted a longer distance such as a few kilometers or tens of kilometers. Regardless of the specific length of transmission of the analog optical signal, the optical transmitter described herein may be used in generating analog optical signals from a digital representation of the signal for transmission remote from the transmission antenna location. The analog optical signals may be transmitted over a transmission fiber, which may be a fiber optic cable.

The environment 100 depicted in FIG. 1 is an oversimplification of a mobile communication network intended to provide a basic overview of an environment in which the optical power system may be used. Further, although described in terms of its use in a mobile communication network, the optical transmitter described further herein may be used in other applications in which it is desirable to provide analog optical signals that are synthesized from digital representations. Such applications may include, for example, cable television head-end transmission, supplying wireless communications to remote areas, or areas where wireless backhaul is not available, as well as other possible applications. In the environment 100 of FIG. 1, applications may also include transmission of signals in the direction from the antenna (see the antenna 210 of FIG. 2) toward the BTS 106.

FIG. 2 depicts components of an analog optical transmitter system. As will be described more fully below, the analog optical transmitter system 200 comprises an optical power supply that provides unmodulated optical carrier waves to optical modulators that modulate the carrier waves according to digital signals. The optical power supply may comprise a number of high-power lasers 202a, 202b, 202c, 202d, 202e, 202f, 202g, and 202h (referred to collectively as lasers 202). While eight lasers 202 are shown, any number of lasers may be used. Each of the lasers 202 outputs an unmodulated optical carrier signal of differing power and differing wavelength, which is represented schematically by the lines in FIG. 2.

The unmodulated optical carrier signals of differing power and wavelength are transmitted to input ports of an optical transmitter 204. While one optical transmitter 204 is shown in FIG. 2, optical transmitter systems 200 may include any number of optical transmitters. The optical transmitter 204 in FIG. 2 includes a bank of eight single-bit optical modulators 203a, 203b, 203c, 203d, 203e, 203f, 203g, and 203h (referred to collectively as optical modulators 203). However, any number of optical modulators 203 may be included in the optical transmitter 204. In some embodiments, the optical modulators 203 are digital drive Mach-Zehnder interferometers, which may also be referred to as Mach-Zehnder modulators. In some embodiments, the optical modulators 203 are 8-bit modulators, 4-bit modulators, 3-bit modulators, 2-bit modulators, single-bit modulators, or combinations thereof. As will be more fully explained below, the optical modulators 203 within the optical transmitter 204 are configured to perform modulation on the optical carrier signals in parallel. In some embodiments, the modulators 203 have a similar high-state transmission and a similar low-state transmission.

The optical transmitter 204 is configured to receive a digital data signal from a driver 206. The digital signal may include a single data bit or a plurality of data bits. For example, the drive signal may be a single-bit drive signal, a two-bit drive signal, a three-bit drive signal, a four-bit drive signal, an eight-bit drive signal, and so on. The driver 206 in FIG. 2 provides the optical transmitter 204 with eight single-bit digital drive signals. Each single-bit drive signal is intended for and received by one of the eight single-bit optical modulators 203 within the optical transmitter 204. In other words, each of the eight single-bit optical modulators 203 within the optical transmitter 204 receives one of the eight single-bit drive signals output by the driver 206.

In an embodiment, the optical modulator 203a within the optical transmitter 204 modulates an optical carrier signal from laser 202a having a first wavelength and a first power using a first data bit from the driver 206 to generate a first modulated output signal. In similar fashion, the optical modulator 203b modulates an optical carrier signal from laser 202b having a second wavelength and a second power using a second data bit received from the driver 206 to generate a second modulated output signal, the optical modulator 203c modulates an optical carrier signal from laser 202c having a third wavelength and a third power using a third data bit received from the driver 206 to generate a third modulated output signal, and so on.

Each optical carrier signal beats with each other optical carrier signal. The signals in the optical link 207 are digital optical signals. The analog waveform is created in the analog photo-receiver 208. To achieve a high signal-to-noise ratio in the analog signal, the bandwidth of each digital optical signal may be much larger than the bandwidth of the analog signal.

In an embodiment, the wavelength of each unmodulated optical carrier signal is separated from other wavelengths by a frequency difference sufficient that the beat frequencies are larger than the transmission spectrum of each digital optical signal on the optical link 207. For exam ple, the wavelength separation may be 100 GHz. In an embodiment, a second power is half of the first power, a third power is half of the second power, and so on. For example, in an embodiment a first optical carrier signal has a power of 50%, a second optical carrier signal has a power of 25%, a third optical carrier signal has a power of 12.5%, and so on.

The eight modulated output signals collectively generated by the optical modulators 203a are output to an optical wavelength multiplexer 205 at eight output ports as shown in FIG. 2. The optical wavelength multiplexer 205 is configured to sum the eight modulated output signals received from the optical modulators 203 into an analog signal suitable for transmission over an optical fiber 207. In an embodiment, the optical wavelength multiplexer 205 is an arrayed waveguide grating (AWG). In an embodiment, the optical wavelength multiplexer 205 is a Y-junction tree. In an embodiment, the optical wavelength multiplexer 205 is a cascade of thin-film optical filters. The choice of AWG or Y-junction tree or cascade of thin-film optical filters may be determined based on insertion loss and power handling requirements.

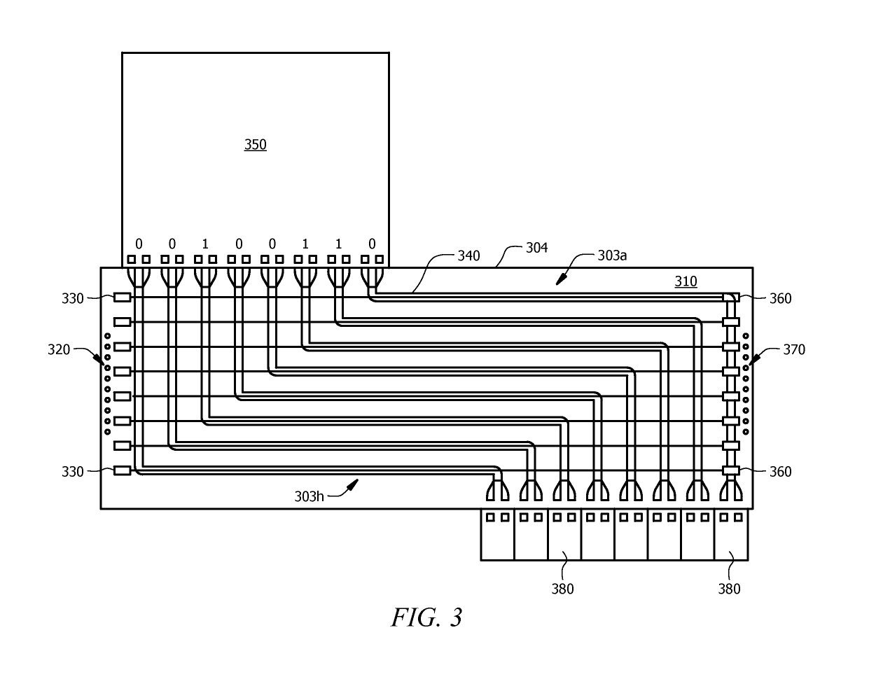

As shown in FIG. 2, the combined modulated analog signal output from the optical wavelength multiplexer 205 is conveyed to an analog photoreceiver 208 over the optical fiber 207. The analog photoreceiver 208, which may also be referred to as a photodetector, may be disposed within a BTS similar to BTS 106 of FIG. 1. The analog photoreceiver 208 generates an electrical signal having an amplitude corresponding to the total power across all wavelengths of the combined analog signal received from the optical wavelength multiplexer 205. The particular wavelengths used herein are not important because the photodetector 208 only detects a total power summed across all wavelengths. The electric signal generated by the photodetector 208 based on the received analog signal may be amplified by one or more power amplifiers 209 to provide an analog driving signal. The analog drive signal is provided to the transmission antenna 210, which causes the transmission antenna 210 to radiate an RF signal. Because of the arrangement and function of components as described herein, there is no need for an optical demultiplexer at the photoreceiver 208. Indeed, the photoreceiver 208 detects the sum total optical power as a function of time and, therefore, produces an analog waveform FIG. 3 depicts an optical transmitter 304 configured on a photo integrated circuit (PIC) 310. The optical transmitter 304 may be similar to the optical transmitter 204 of FIG. 2. The optical transmitter 304 includes multiple wavelength optical input ports 320. The optical input ports 320 may be edge or surface grating coupled. While eight of the optical input ports 320 are shown, any number of optical inputs may be used. The optical input ports 320 are configured to receive the unmodulated optical carrier signals from, for example, the lasers 202 shown in FIG. 2.

The optical input ports 320 provide the unmodulated optical carrier signals to the optical modulators 303. The optical modulators 303 may be similar to the optical modulators 203 in FIG. 2. As represented in FIG. 3, the optical modulators 303 are Mach-Zehnder modulators, each comprising an optical power splitter 330 having two dual output optical waveguides, an optical phase shifter 340 acting upon one or both of said dual optical waveguides, and an optical power combiner 360. The optical phase shifter 340 is driven by an electrical digital signal from the driver chip 350. The optical output ports 370 convey the modulated signal from each Mach-Zehnder optical modulator toward an optical multiplexer which may be similar to the optical multiplexer 205 in FIG. 2. By changing the relative optical phase of the two optical waveguides at the optical power combiner 360, the Mach-Zehnder optical modulator produces an amplitude-modulated optical signal, according to the electrical signal applied by the driver chip 350.

As shown in FIG. 3, the driver chip 350 is configured to provide an eight-bit digital signal (e.g., ‘00100110’). However, the driver chip 350 may be configured to provide a digital signal with any number of bits. Each of the optical modulators 303 in FIG. 3 is a single-bit modulator, meaning that the optical modulators are configured to modulate the unmodulated optical carrier signal in the optical waveguide 340 with a single data bit. However, in other embodiments the optical modulators 303 may be configured to accommodate additional bits. In such cases, the driver chip 350 provides a digital signal with a corresponding number of bits. For example, if the optical modulators 303 are two-bit modulators and there are eight of them, the driver chip 350 provides a digital signal with 16 total bits.

As shown in FIG. 3, the dual waveguide 340 of the upper optical modulator 303a is the least significant bit phase shifter while the dual waveguide 340 of the lower optical modulator 303h is the most significant bit phase shifter. The bits disposed between the most significant bit and the least significant bit are provided, in order, to the optical modulators 303 positioned between the upper and lower optical modulators 303 in FIG. 3. In other embodiments, the arrangement of the most significant bit phase shifter, the least significant bit phase shifter, and the other phase shifters in between may be different.

In an embodiment, the drive signals from the driver chip 350 pass through the PIC 310, as noted above, to termination resistor chips 380. In an embodiment, the termination resistor chips 380 are remotely located relative to the PIC 310.

The optical modulators 303 of FIG. 3 use the data bits in the digital signals provided by the driver chip 350 to modulate the optical carrier signals passing through the waveguides 340. Because the optical carrier signals were split by the splitters 330, the optical carrier signals are recombined by an optical combiner 360 within each optical modulator 303 to generate the modulated optical carrier signals. The modulated optical carrier signals are then provided to optical outputs 370. While eight of the optical outputs 370 are shown, any number of optical outputs may be used. The number of optical outputs 370 corresponds to the number of optical inputs 320. The optical outputs 370 are configured to output the modulated optical carrier signals from the optical transmitter 304. In an embodiment, the optical outputs 370 provide the modulated optical carrier signals to a multiplexer such as, for example, the multiplexer 205 of FIG. 2.

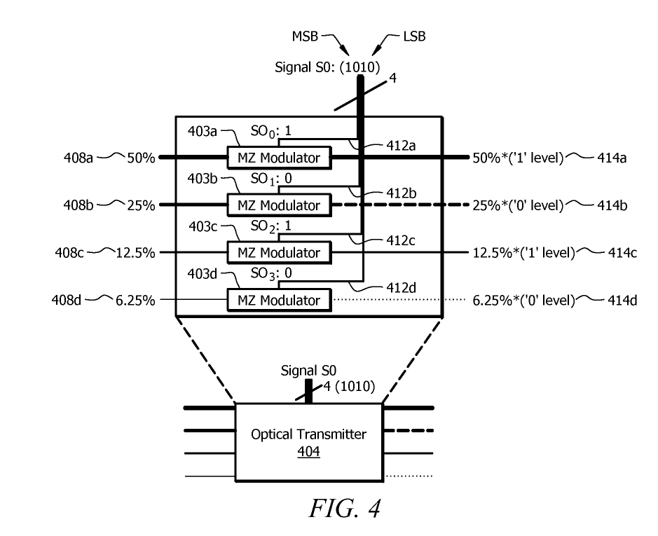

FIG. 4 is an embodiment of an optical transmitter 404 having four one-bit optical modulators 403. The optical transmitter 404 and optical modulators 403 may be similar to the optical transmitter 204, 304 and optical modulators 203, 303 in FIGS. 2 and 3. The optical transmitter 404 receives a plurality of inputs 408a, 408b, 408c, 408d (referred to collectively as inputs 408). Each of the inputs 408 is modulated according to a single bit of the data signal being transmitted. As depicted in FIG. 4, the signal S0 being transmitted comprises 4 bits, which are depicted as the bit string ‘1010’, and as such the optical transmitter 406 comprises four inputs 408 and modulators 403. Generally, the number of inputs and associated individual modulators will correspond to the number of bits of the digital signal. However, it is possible to configure a modulator with more inputs and individual modulators to be used to modulate a digital signal with fewer bits. The inputs 408 receive respective unmodulated optical carrier waves from the optical splitter groups associated with different laser. Accordingly, each of the inputs is associated with a different wavelength. Further, the power provided by the lasers to each of the inputs differs. For example, the first input 408a receives an optical carrier wave of a first wavelength at approximately 50% the optical power output by the lasers. Similarly, the second input 408b receives an optical carrier wave of a second wavelength at approximately 25% the optical power output by the lasers. The third input 408c receives an optical carrier wave of a third wavelength at approximately 12.5% the optical power output by the lasers. The fourth input 408d receives an optical carrier wave of a fourth wavelength at approximately 6.25% the optical power output by the lasers.

The optical transmitter 404 includes a number of individual optical modulators 403a, 403b, 403c, 403d (referred to collectively as optical modulators 403) for modulating the optical signal from a respective one of the inputs in accordance with a corresponding bit of the data signal. The optical modulator 403a modulates the highest power optical input, namely input 408a, using the most significant bit, S0₀ 412a, of the digital signal. The optical modulator 403b modulates the second highest power optical input, namely input 412b, using the second most significant bit, S0₁ 412b, of the digital signal. The optical modulator 403c modulates the second lowest power optical input, namely input 408c, using the second least significant bit, S02 412c, of the digital signal. The optical modulator 403d modulates the lowest power optical input, namely input 408d, using the least significant bit, SO₃ 412d, of the digital signal. The optical modulators 403 collectively provide the modulated input carrier waves as outputs 414a, 414b, 414c, 414d.

The individual optical modulators 403 modulate the power of the respective input carrier wave based on the associated bit of the digital signal. The output of each individual modulator will depend upon the optical power of the input carrier wave and the bit value. This is represented in FIG. 4 by the respective optical power of the input (50%, 25%, 12.5%, 6.25%) multiplied by the modulation level for a ‘0’ bit or a ‘1’ bit.

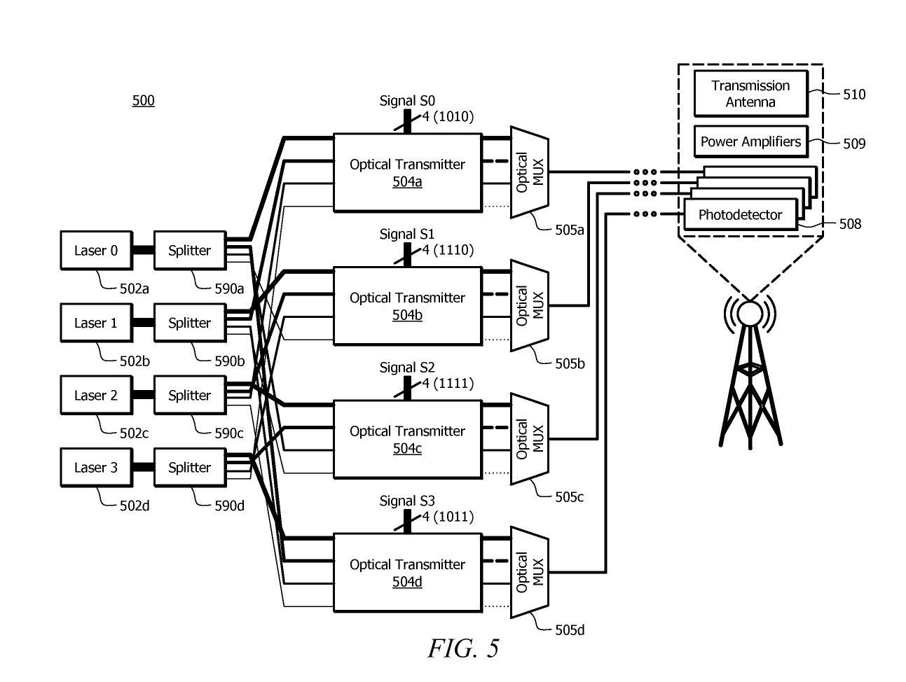

FIG. 5 depicts components of an analog optical transmitter system. The analog optical transmitter system 500 is similar to the optical system 200 of FIG. 2. The system 500 comprises an optical power supply that provides unmodulated optical carrier waves to optical transmitters 504 that each use a bank of optical modulators (not shown) to modulate the carrier waves according to digital signals. The optical transmitters 504 in FIG. 5 are similar to the optical transmitter 404 of FIG. 4.

The optical power supply may comprise a number of high-power lasers 502a, 502b, 502c, 502d (referred to collectively as lasers 502) and a plurality of optical splitters 590a, 590b, 590c, 590d (referred to collectively as optical splitters 590). The output of each laser is connected to a respective one of the optical splitters 590. Each of the optical splitters 590 splits the input into a number of output ports of differing power, which is represented schematically by the thickness of the line in FIG. 5. For example, the thickest line may represent 50% power, the second thickest line may represent 25% power, the second thinnest line may represent 12.5% power, and the thinnest line may represent 6.25% power.

The output ports of the optical splitters 590 are connected to modulator inputs of a number of optical transmitters 504a, 504b, 504c, 504d (referred to collectively as optical transmitters 504). Each of the optical transmitters 504 modulate the optical carrier waves from the inputs according to individual bits of respective digital signals S0-S3 associated with the respective one of the optical transmitters 504.

The optical transmitters 504 provide output ports for the modulated optical carrier waves and the output ports are connected to respective optical multiplexers 505a, 505b, 505c, 505d (referred to collectively as optical multiplexers 505). The optical multiplexers 505 may be similar to the optical multiplexer 205 in FIG. 2. Each of the optical multiplexers 505 multiplex the modulated optical carrier waves from one of the optical transmitters 504 together into a single analog optical signal that can be transmitted over a fiber optic transmission link.

The analog optical signals provided by the optical multiplexers 505 may be transmitted over the optical fiber to a transmission antenna location, where a respective photodetector 508 converts the optical signal into a corresponding electrical signal. The photodetector 508 may be similar to the photoreceiver 208 of FIG. 2. The electrical signals from the photodetector 508 may be amplified by power amplifiers 509. The power amplifier 509 may be similar to the amplifier 209 of FIG. 2. The amplified signals are used to drive transmission antennas 510. The transmission antennas 510 may be similar to the antenna 210 of FIG. 2.

The analog optical transmitter system 500 may be located remote from the transmission antenna 510. For example, the analog optical transmitter system 500 may be located at a base of a cellular tower on which the transmission antenna is located. Additionally or alternatively, the analog transmitter system 500 may be located remotely from the transmission site. The lasers 502 may be co-located with the optical transmitters 504 and optical multiplexers 505 or may be located separately from other components such as the splitters 590, optical transmitters 504, and optical multiplexers 505. The performance of the lasers 502 may be more susceptible to changing environmental conditions and as such may be located in a more highly regulated environment to ensure optimal, or at least acceptable operation is maintained. The optical splitters 590, optical transmitters 504, and optical multiplexers 505 may be more robust with regard to sensitivity to environmental conditions and as such may be located in a wider range of locations. The optical splitters 590, optical transmitters 504, and optical multiplexers 505 may located together or separately and may be co-located with the lasers 502 or may be located separately. For the uplink direction, the optical lasers 502 may be at the foot of the tower and the optical transmitters 504 may be at the top of the tower. For the downlink direction, the lasers 502 may be at a BSC/RNC location similar to 104 of FIG. 1 and the optical transmitters 504 may be at the foot of the tower.

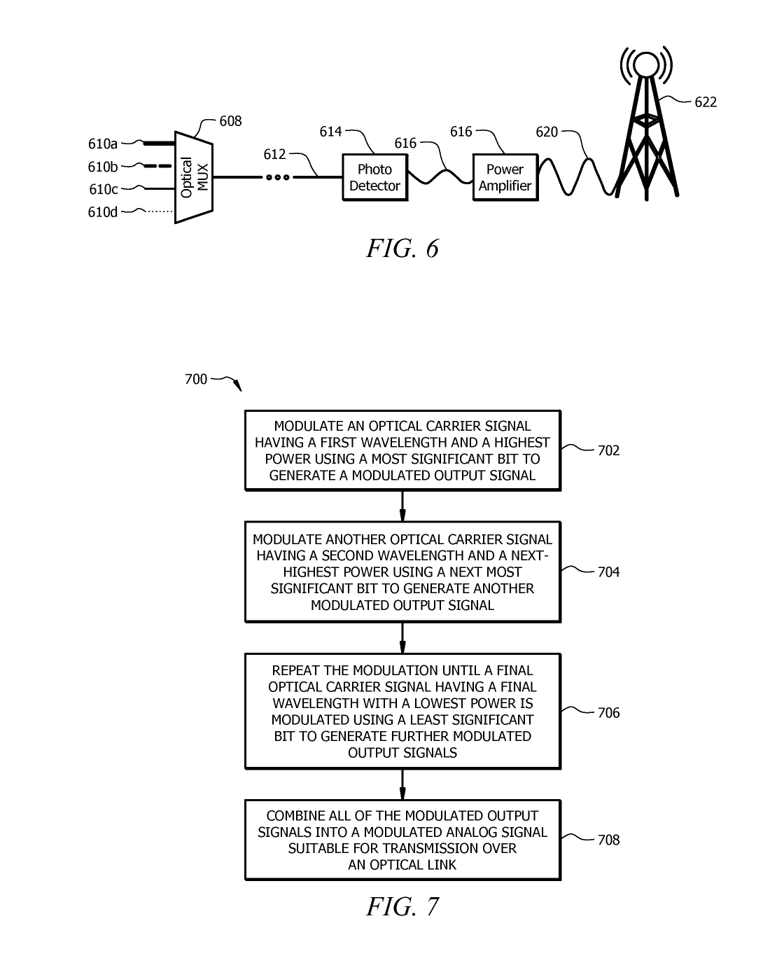

FIG. 6 depicts components of the digital-to-analog communication link. As depicted by way of example in FIG. 6, an optical multiplexer 608 receives a plurality of inputs 610a, 610b, 610c, 610d (referred to collectively as inputs 610). The optical multiplexer 608 may be similar to the multiplexer 205, 505 in FIGS. 2 and 5. The inputs 610 correspond to individual bits of a data signal, which is depicted as being a 4-bit signal. The inputs 610 are received at the optical multiplexer 608 and combined together into a single optical signal 612. Each of the optical signals of the input 610 may have different wavelengths that are separated from each other in order to avoid generating any beat frequencies in the output when combined together. The combined optical signal 612 is transmitted over a transmission link to a photodetector 614. The photodetector 614 may be similar to the photodetector 208, 508 in FIGS. 2 and 5. The photodetector 614 generates an electrical signal 616 having an amplitude corresponding to the total power across all wavelengths of the combined optical signal 612. The electrical signal 616 may be amplified by one or more power amplifier 618 to provide an analog driving signal 620 that is provided to the transmission antenna 622, and causes the transmission antenna 622 to radiate the RF signal. The amplifier 618 and the antenna 622 may be similar to the amplifier 209, 509 and the antenna 210, 510 in FIGS. 2 and 5.

FIG. 7 is a method 700 of optical transmission. The method 700 may be initiated and performed in order to generate an optical transmission suitable for delivery to a photodetector over an optical fiber. The method 700 may be implemented by one of the optical transmitters disclosed herein, such as the optical transmitter 204, 304, 404, 504 of FIGS. 2-5. In block 702, an optical carrier signal having a first wavelength and a highest power is modulated using a most significant bit to generate a modulated output signal. In an embodiment, the modulation is performed by an optical modulator similar to the optical modulator 203, 403 of FIGS. 2 and 4. In block 704, another optical carrier signal having a second wavelength and a next-highest power is modulated using a next most significant bit to generate another modulated output signal. In an embodiment, the modulation is performed by another optical modulator similar to the optical modulator 203, 403 of FIGS. 2 and 4. In block 706, the modulation is repeated, using a further optical modulator, until modulating a final optical carrier signal having a final wavelength with a lowest power using a least significant bit to generate further modulated output signals. In an embodiment, the modulation is performed by a further optical modulator similar to the optical modulator 203, 403 of FIGS. 2 and 4. In block 708, all of the modulated output signals are combined into a modulated analog signal suitable for transmission over an optical fiber. The modulated analog signal may be received by a photodetector, amplified, and then transmitted as an RF signal as described above.

From the foregoing, those skilled in the art will appreciate that a plurality of modulators are arranged in parallel in a multiple channel optical transmitter. Multiple parallel single-wavelength modulated signals are summed and sent through optical fiber to a detector. Analog optical transmitters have proportional relative power relationships, creating parallel transmitted optical signals. As such, a full analog signal is received at the photodetector at the end of the optical fiber. The actual wavelengths of each bit are not important, because at the photoreceiver all of the optical power is simply added. Indeed, the analog signal is determined by adding a sum of the bits corresponding to an optical modulation amplitude at signal frequency and a sum of the bits corresponding to a logic zero optical power at a digital carrier frequency. The optical modulation amplitude of each bit is in a binary sequence at the photoreceiver. In addition, assuming all the modulators are identical, then the optical modulation amplitude is proportional to the optical power into the modulator. The optical power supply or the splitters divide the power into a binary sequence such as, for example, the fractions ½, ¼, ⅛, 1/16, 1/32, 1/64, 1/128, and 1/256 for an eight-bit signal and send one of these powers into each of the modulators.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. An optical transmitter, comprising:
a first optical modulator configured to modulate a first optical carrier signal having a first wavelength and a first power using a first data bit to generate a first modulated output signal;
a second optical modulator configured to modulate a second optical carrier signal having a second wavelength and a second power using a second data bit to generate a second modulated output signal, wherein the second optical modulator and the first optical modulator modulate in parallel; and
an optical wavelength multiplexer operably coupled to the first optical modulator and the second optical modulator, wherein the optical wavelength multiplexer is configured to sum the first modulated output signal and the second modulated output signal into an analog signal suitable for transmission over an optical fiber.

2. The optical transmitter of claim 1, wherein the first optical modulator receives the first optical carrier signal from a first laser, wherein the second optical modulator receives the second optical carrier signal from a second laser, and wherein the second power is less than the first power.

3. The optical transmitter of claim 1, wherein at least one of the first optical modulator and the second optical modulator is a Mach-Zehnder modulator.

4. The optical transmitter of claim 1, wherein the first wavelength is separated from the second wavelength by at least one hundred gigahertz (GHz), and wherein the second power is one half of the first power.

5. The optical transmitter of claim 1, wherein the first data bit and the second data bit are from a same digital signal comprising a plurality of bits, and wherein the first data bit is a most significant bit and the second data bit is a least significant bit.

6. The optical transmitter of claim 1, wherein the first optical carrier signal having the first wavelength and the first power and the second optical carrier signal having the second wavelength and the second power are both received from an optical splitter coupled to a laser.

7. The optical transmitter of claim 1, wherein the first optical modulator is coupled to a first optical input configured to receive the first optical carrier signal, and wherein the second optical modulator is coupled to a second optical input configured to receive the second optical carrier signal.

8. The optical transmitter of claim 1, wherein the first data bit and the second data are each received from a microwave driver chip, and wherein the first optical modulator and the second optical modulator are disposed on a photonic integrated circuit (PIC).

9. The optical transmitter of claim 1, wherein the optical wavelength multiplexer is one of an arrayed waveguide grating, a Y-junction tree, and a cascade of thin-film filters.

10. The optical transmitter of claim 1, wherein the optical wavelength multiplexer is configured to transmit the analog signal to an analog photoreceiver over the optical fiber.

11. An optical transmitter, comprising:
optical modulators configured to modulate optical carrier signals, wherein each of the optical carrier signals has a different wavelength, and wherein modulation by the optical modulators is performed in parallel on the optical carrier signals from a highest power optical carrier signal modulated using a most significant bit of a digital signal through a lowest power optical carrier signal modulated using a least significant bit of the digital signal to generate modulated output signals; and
an optical wavelength multiplexer operably coupled to the optical modulators and configured to sum the modulated output signals into an analog signal suitable for transmission to an analog photoreceiver over an optical fiber.

12. The optical transmitter of claim 11, wherein a number of the optical modulators is equal to a number of the different wavelengths of the optical carrier signals.

13. The optical transmitter of claim 11, wherein the optical modulators are one of eight-bit modulators, four-bit modulators, and two-bit modulators, and wherein the digital signal is between 8-bits and 2-bits.

14. The optical transmitter of claim 11, wherein at least one of the optical modulators is configured to use more than one bit.

15. The optical transmitter of claim 11, wherein the optical modulators are disposed on a photonic integrated circuit (PIC) operably coupled to a drive signal chip, and wherein the drive signal chip is configured to provide the digital signal to the optical modulators.

16. The optical transmitter of claim 11, wherein the different wavelengths are separated from each other by at least one hundred gigahertz (GHz).

17. The optical transmitter of claim 11, wherein the highest power optical carrier signal is one half of a next-highest power optical carrier signal.

18. A method of optical transmission, comprising:
modulating, using one optical modulator, an optical carrier signal having a first wavelength and a highest power using a most significant bit to generate a modulated output signal;
modulating, using another optical modulator, another optical carrier signal having a different wavelength and a next-highest power using a next most significant bit to generate another modulated output signal;
repeating the modulating, using a further optical modulator, until modulating a final optical carrier signal having a final wavelength with a lowest power using a least significant bit to generate further modulated output signals; and
combining all of the modulated output signals into a modulated analog signal suitable for transmission over an optical fiber.

19. The method of claim 18, further comprising performing each modulating step in parallel.

20. The method of claim 18, further comprising separating the first wavelength from the different wavelength by at least one hundred gigahertz (GHz).

21. The method of claim 18, further comprising dividing the highest power in half to obtain the next-highest power.

22. The method of claim 18, further comprising transmitting the modulated analog signal to an analog photoreceiver over the optical fiber.
